(19) United States
(12) Patent Application Publication
(10) Pub. No.: US 2001/0032090 A1
(43) Pub. Date: Oct. 18, 2001

(54) One-line registration

(76) Inventor: Ahmed Moneim, Santa Clara, CA (US)

Correspondence Address: ESYNAPSE CORP, C/O AHMED MONEIM, 50 MOUNTAIN SPRING AVE, SAN FRANCISCO, CA, 94114, US

(21) Appl. No.: 09/739,077

(22) Filed: Dec. 13, 2000

Related U.S. Application Data
(60) Provisional application No. 60/170,872, filed on Dec. 14, 1999.

(51) Int. Cl. G06F 17/60

(52) U.S. Cl. 705/1

(57) ABSTRACT

A system or method whereby the users of a computer network, such as Internet, may enter all information required by the requested site as one single text box where the information provided by the users will be entered according to the title above the text box using a slash or any mean of separation between each category as indicated by the software. Such process will bring an easier, faster and more convenient way to register, sign in, login and/or enter information over a computer network such as Internet, either via a personal computer or a wireless device, by a single click in a single line. This method will also save time of users who participate in a registration or input process, plus this will require less room to be displayed, which will lead also to increase clients and e-commerce over the Internet.

### FIELD OF INVENTION

This present invention relates to a system, formula or method to register, login or sign in users over a computer network, such as the Internet where all required information will be entered in one line. The one-line registration can be implemented by software programming apparatus.

### BACKGROUND OF THE INVENTION

Traditionally, users of the Internet need to register, login, sign in, or fill an application in order to enter or participate in activities related to the web site or company they visit on the Internet.

In order to do so, users need to fill a form containing more than one line. Each line represents a category such as: name, email, password, address, zip code and other information according to the form users need to complete.

This procedure takes a relatively long time and requires the user to click many times to move the cursor from one-line to another. This discourages people from filling in applications; leaving the web site without registering, and thereby loosing potential customers.

The drawbacks for traditional registration forms or sign in forms are that:

(1) Take a long time for user to login and fill all required lines.

(2) Give the impression of a long form to fill, which will discourage user.

(3) Take more room or even an extra web page to display registration or transaction forms, such room can be used by the websites for other purposes.

(4) Require users to click more than one time in order to complete the process.

### SUMMARY OF THE INVENTION

Internet is a fast expanding field, and more and more people use it every day. A very important factor to help to expand the Internet era to more users or customers is to make it easier and faster to use. Another significant factor is to save more room to display more important information. This is the reason why the process of one-line registration will help the users to register faster and more conveniently. Also, it will increase the flow of users. Plus, the registration form can be implemented in the homepage rather than forcing the user to go to another link-page to register.

The object of the present invention is to provide a method for conducting a one-line registration form where all information will be entered in one-line separated by slash or any other mean to identify each category of information or data.

### DESCRIPTION OF THE DRAWINGS

FIG. 1 illustrates an overview of one embodiment of conducting one-line registration with the present invention.

FIG. 2 illustrates an overview of one embodiment of conducting a one-click sign in with the present invention

FIG. 3 illustrates one embodiment of storing data received by the present invention into a traditional database server.

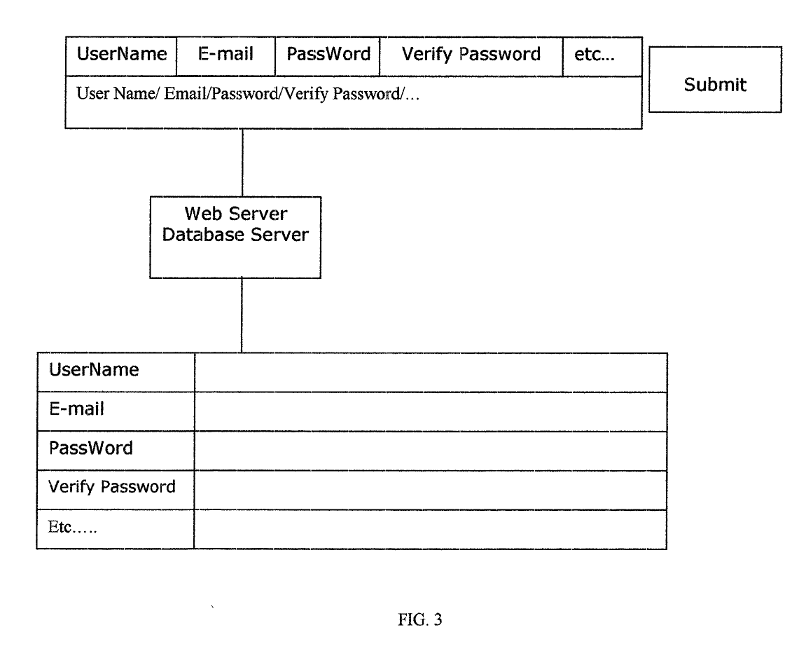

FIG. 4 illustrates one embodiment of exchanging data, entered by users, among websites using one-line registration.

### DESCRIPTION AND OPERATION OF THE INVENTION

The present invention is conceived as a plug-in that will let users submit information to a website database server in one single text-box that takes less space and requires fewer pages for the different Internet processes. It also facilitates users transactions over the Internet (registration, login, payments, etc.), allowing them to participate with their usernames in websites affiliated to this new method of registration to build a web sites network over the Internet. The utilization of this invention is considering connections from wireless devices to register or submit information in the same way.

The manner the present invention will work is as follow:

1. A user is connected to a computer network such as the Internet, and he/she will be asked to enter information to register, sign in, open an account, or login by the requesting website.

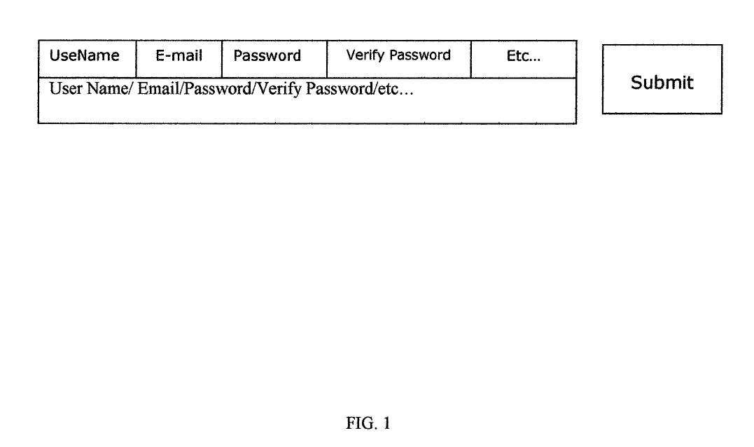

2. He/she will fill a one single line form, as shown in FIG. 1.

3. Titles of the data requested will be displayed on the top of the text box to guide users about the information needed to type or enter.

4. The users will summit the type of data according to the title, then place a slash (/) or any other mean of separation right next to the last letter of entered information, and so on; following the same order until all the requested information is entered.

5. Then, the user will click on the submit button or hit on the Enter or Return key that will send all this information to the web server.

6. Users can edit all the information before submiting it.

7. The order and required information of this model can be altered and adjusted to fit the best interest of who request it, including the addition of more categories and the registering confirmation by email.

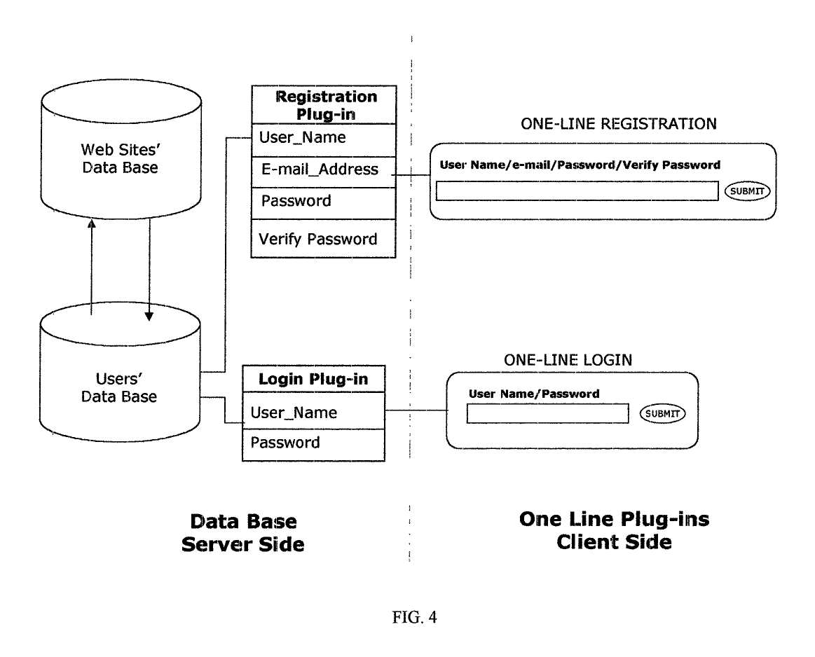

8. Data can be share between many different websites, in order to make users register only once. The users' information will be collected by a common server in one single database, which will let users go to another website that uses One-line Registration to sign in right away, without he/she needs to register again, as shown in FIG. 4.

The standard model will be as follow:

For one-line registration: E-mail/username/password/verify password, as shown in FIG. 1.

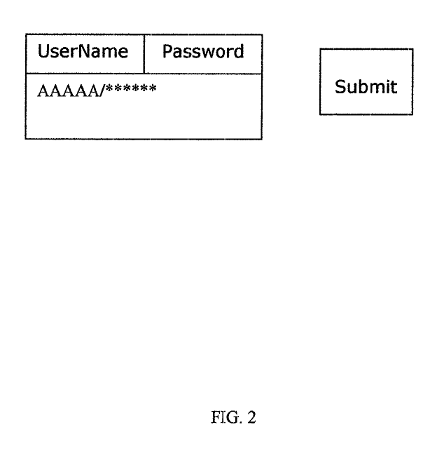

For one-line sign in or login: User name/password as shown in FIG. 2.

The present model has been designed to allow many users to participate in the registration and transaction processes over the Internet, providing a rapid login and also an easy way to have more information in a single page. This is accomplished by using fewer pages, thereby requiring less time from the users to fill in a form and consequently websites will have more clients.

Although, various preferred embodiments of the present invention have been described in detail, it will be appreciated by those skilled in the art that variations may be made thereto without departing from the spirit of the invention or the scope of the appended claims,

Furthermore, since numerous modifications and variations will readily occur to those skilled in the art, it is not desired that the present invention be limited to the exact construction and operation illustrated and described herein and accordingly, all suitable modification and equivalents, which may be resorted to are intended to fall within the scope of the claims.

I claim:

1. A method of registering data over the internet where said data will be typed and displayed in one-line textbox and separated by a slash (/) or another character like * or #, to distinguish the category of said data entered; such process can be implemented by using a software apparatus that will be a plug-in to be used into web sites and wireless devices, the method consist of:
a) displaying the category's titles of said entry data above the text box to guide the user summits the related information to said title;
b) entering said entry data in the text box;
c) skipping the present title by pressing twice the separator;
d) editing the said data at any time by cursor movement before submitting;
e) pressing a button or hitting the Enter key to submit the entry data to a server;
f) storing said data in a database;
e) Process further including the same design, a single text box to sign in or login, entering username and password, which will be not display on the screen as shown in FIG. 2;
f) Process further including submitting, and securing credit card information, or payment methods;
h) Process further including other processes that need submitting data.
i) Process further including the plug-in design regarding to the shape, length, color, size, animation or sound to be used in the present invention;
j) Process further including the software or technology to implement this method;
k) Process further including a server to collect data and share said between websites allowing users to login to different websites using the same method, one-line registration, without registering again.
